(19) United States
(12) Patent Application Publication
(10) Pub. No.: US 2005/0073254 A1
(43) Pub. Date: Apr. 7, 2005

(54) Plasma display panel

(75) Inventors: Kohsuke Masuda, Yamanashi-ken (JP); Atsushi Hirota, Yamanashi-ken (JP); Kimio Amemiya, Yamanashi-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Pioneer Corporation

(21) Appl. No.: 10/953,763

(22) Filed: Sep. 30, 2004

(30) Foreign Application Priority Data
Oct. 1, 2003 (JP) JP 2003-342856

(51) Int. Cl. H01J 17/49

(52) U.S. Cl. 313/584

(57) ABSTRACT

A projecting electrode of each of row electrodes constituting a row electrode pair faces a discharge cell and has a resistance value between 0.05 to 1.0 times inductance of a discharge space during discharge peak current occurring in the discharge cell by discharge that is produced between the row electrodes of the row electrode pair.

### BACKGROUND OF THE INVENTION

1. Field of the Invention

This invention relates to structure of plasma display panels.

The present application claims priority from Japanese Application No. 2003-342856, the disclosure of which is incorporated herein by reference.

2. Description of the Related Art

A surface-discharge-type AC plasma display panel (hereinafter referred to as “PDP”) includes two opposite glass substrates between which a discharge-gas-filled discharge space is defined. Row electrode pairs each extending in a row direction are arranged in a column direction on one of the two glass substrate. Column electrodes extending in the column direction are arranged in the row direction on the other glass substrate. Unit light emission areas (discharge cells) are formed in matrix form at intersections of the row electrode pairs and the column electrodes within the discharge space.

For the generation of an image on the panel surface, the PDP selectively produces addressing discharge between the column electrode and one row electrode in the row electrode pair, whereby wall charges are accumulated on a dielectric layer covering the row electrodes. In the selected discharge cells thus storing the wall charges (light-emitting cells), sustain discharge is caused between the row electrodes constituting of the row electrode pair to allow red-, green-, and blue-colored phosphor layers individually formed in the discharge cells to emit visible light for the formation of the image.

When such a conventional AC PDP produces sustain discharge between the row electrodes of each row electrode pair for the formation of the image, the discharge electric-current flows intensively for a very short time, and therefore shows a large peak value. This large current gives rise to the problem of the display-characteristic degradation, for example.

### SUMMARY OF THE INVENTION

It is an object of the present invention to provide a plasma display panel which is capable of fixing the problem associated with the conventional PDP and improving display characteristics.

According to the present invention, a plasma display panel includes a pair of substrates that are placed opposite each other with a discharge space in between; a plurality of row electrode pairs that are provided between the substrates; and a plurality of column electrodes that are provided between the substrates and each extends in a direction at right angles to the row electrode pair to form unit light emission areas at intersections with the row electrode pairs within the discharge space. Each of the row electrode pairs is constituted of row electrodes. The row electrode includes a portion that faces the unit light emission area and has a resistance value between 0.05 to 1.0 times inductance of the discharge space during discharge peak current occurring in the unit light emission area by discharge produced between the paired row electrodes of the row electrode pair.

With this PDP, a portion of each of the row electrodes of the row electrode pair that forms a unit light emission area at intersections with the column electrodes within the discharge space faces the unit light emission area, and has a resistance value between 0.05 to 1.0 times the inductance of the discharge space during the discharge peak current occurring in the unit light emission area by discharge produced between the row electrodes of the row electrode pair. Because of such determined resistance value, the discharge peak current generated upon the discharge produced in the unit light emission area is reduced.

Thus, occurrence of current waveform distortion, a reduction in luminous efficiency, and the like are inhibited, and therefore the display characteristics of the PDP are improved.

The present invention is applicable to a type of a PDP having a structure in which a projecting electrode portion of each of the row electrodes of a row electrode pair extends in strip form in the row direction, as well as a type of a PDP having the structure in which the projecting electrode portion of each of the row electrodes of the row electrode pair projects in island form from the electrode body in the row direction toward the counterpart in the paired row electrodes in each unit light emission area.

These and other objects and features of the present invention will become more apparent from the following detailed description with reference to the accompanying drawings.

### BRIEF DESCRIPTION OF THE DRAWINGS

FIG. 1 is a front view illustrating a first and a second embodiment according to the present invention.

FIG. 2 is a sectional view taken along the V1-V1 line in FIG. 1.

FIG. 3 is a sectional view taken along the V2-V2 line in FIG. 1.

FIG. 4 is a sectional view taken along the W1-W1 line in FIG. 1.

FIG. 5 is a sectional view taken along the W2-W2 line in FIG. 1.

FIG. 6 is a front view illustrating a third and a fourth embodiment according to the present invention.

FIG. 7 is a sectional view taken along the V3-V3 line in FIG. 6.

FIG. 8 is a front view illustrating a fifth and a sixth embodiment according to the present invention.

FIG. 9 is a sectional view taken along the V4-V4 line in FIG. 8.

FIG. 10 is a graph showing a comparison between a discharge peak current generated by projecting electrodes designed to have high resistance and a discharge peak current generated by conventional low-resistance electrodes.

### DETAILED DESCRIPTION OF THE PREFERRED EMBODIMENTS

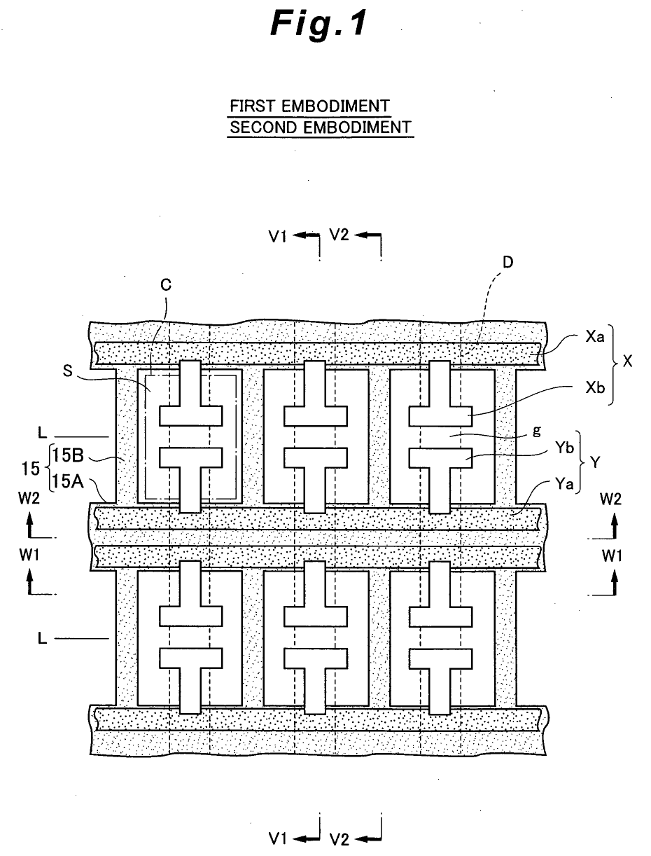

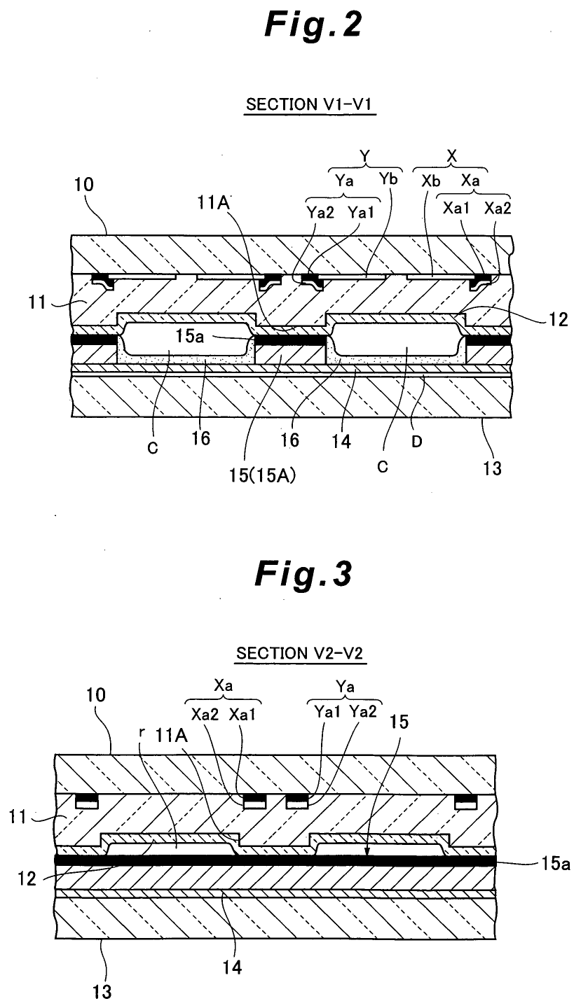

FIGS. 1 to 5 illustrate a first embodiment according to the present invention. FIG. 1 is a schematic front view of the cell structure of a surface-discharge-type AC PDP according to the first embodiment. FIGS. 2, 3, 4 and 5 are sectional views respectively taken along the V1-V1 line, the V2-V2 line, the W1-W1 line and the W2-W2 line as shown in FIG. 1.

In FIGS. 1 to 5, a plurality of row electrode pairs (X, Y) is arranged on the rear-facing face of a front glass substrate 10 serving as a display surface, and each row electrode pair (X, Y) extends in a row direction (i.e. in the right-left direction of FIG. 1) of the front glass substrate 10.

The row electrode X is composed of a bus electrode Xa that is formed of a metal film extending in the row direction of the front glass substrate 10, and a plurality of projecting electrodes Xb each which is formed of a T-shaped transparent conductive film made of ITO or the like. The projecting electrodes Xb are lined up along the bus electrode Xa at regular intervals, and connected to the bus electrode Xa at the proximal ends (corresponding to the foot of the T shape) thereof.

The bus electrode Xa is formed in a double layer structure consisting of a black-colored conductive layer Xa1 placed close to the display surface and a main conductive layer Xa2 placed behind the conductive layer Xa1.

Likewise, the row electrode Y is composed of a bus electrode Ya that is formed of a metal film extending in the row direction of the front glass substrate 10, and a plurality of projecting electrodes Yb each which is formed of a T-shaped transparent conductive film made of ITO or the like. The projecting electrodes Yb are lined up along the bus electrode Ya at regular intervals, and connected to the bus electrode Ya at the proximal ends (corresponding to the foot of the T shape) thereof.

The bus electrode Ya is formed in a double layer structure consisting of a black-colored conductive layer Ya1 that is placed close to the display surface and a main conductive layer Ya2 that is placed behind the conductive layer Ya1.

The row electrodes X and Y are arranged in alternate positions in a column direction (i.e. the vertical direction in FIG. 1) of the front glass substrate 10. In each row electrode pair (X, Y), the projecting electrodes Xb and Yb, which are lined up along the associated bus electrodes Xa and Ya, extend in the direction toward its counterpart in the row electrode pair, so that the two widened-tops (corresponding to the head of the T shape) of the projecting electrodes Xb and Yb face each other with a discharge gap g having a required width in between.

A dielectric layer 11 is provided on the rear-facing face of the front glass substrate 10 and covers the row electrode pairs (X, Y).

In turn, additional dielectric layers 11A project from the rear-facing face of the dielectric layer 11 toward the rear of the PDP. Each of the additional dielectric layers 11A extends parallel to the back-to-back bus electrodes Xa, Ya of the two row electrode pairs (X, Y) adjacent to each other in the column direction, and opposite the back-to-back bus electrodes Xa, Ya and the area between the back-to-back bus electrodes Xa, Ya.

The rear-facing faces of the dielectric layer 11 and the additional dielectric layers 11A are covered with an. MgO made protective layer 12.

A back glass substrate 13 is located parallel to the front glass substrate 10 at a predetermined interval. Column electrodes D are arranged parallel to each other at predetermined intervals on the front-facing face of the back glass substrate 13 facing the front glass substrate 10. Each of the column electrodes D extends in a direction at right angles to the row electrode pair (X, Y) (i.e. in the column direction) in a position opposite to the paired projecting electrodes Xb and Yb of each row electrode pair (X, Y).

The column electrodes D are covered with a column-electrode protective layer (dielectric layer) 14 that is provided on the front-facing face of the back glass substrate 13. Then a partition wall member 15 is provided on the column-electrode protective layer 14.

The partition wall member 15 is formed substantially in a grid shape having transverse walls 15A each extending in the row direction and opposite the additional dielectric layer 11A, and vertical walls 15B each extending in the column direction an opposite an area between adjacent column electrodes which are arranged parallel to each other.

The gird-shaped partition wall member 15 partitions a discharge space S defined between the front glass substrate 10 and the back glass substrate 13 into quadrangular discharge cells (unit light emission areas) C. Each of the discharge cells C is situated in a position facing the paired projecting electrodes Xb and Yb of each row electrode pair (X, Y).

A black-colored layer (light absorption layer) 15a is formed on a front-facing face of the partition wall member 15 facing toward the front glass substrate 10.

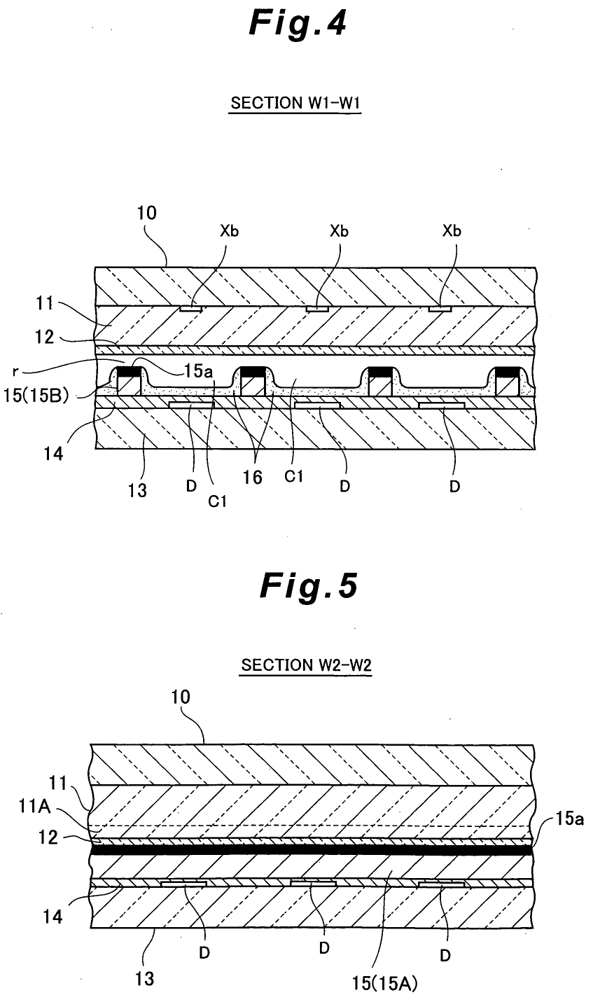

The front-facing face to the vertical wall 15B of the partition wall member 15 is out of contract with the protective layer 12 (see FIGS. 3 and 4) so as to form a clearance r. The front-facing face of the transverse wall 15A is in contact with a portion of the protective layer 12 overlaying the additional dielectric layer 11A (see FIGS. 3 and 5) to block adjoining discharge cells C in the column direction from each other.

In each discharge cell C, a phosphor layer 16 is laid on five faces: the front-facing face of the column-electrode protective layer 14 and the side faces of the transverse walls 15A and the vertical walls 15B of the partition wall member 15.

The three primary colors, red, green and blue, are applied individually to the phosphor layers 16 such that the red, green and blue discharge cells C are arranged in order in the row direction.

The discharge space S is filled with a xenon-included discharge gas.

In the PDP, each of the row electrode pairs (X, Y) forms a display line (row) L of a matrix display screen.

For displaying an image on the PDP, after the completion of reset discharge, discharge (addressing discharge) is selectively produced between the column electrode D and one row electrode in the row electrode pair (X, Y) in each discharge cell C. Thereupon, light-emitting cells (i.e. the discharge cells C in which wall charges are generated on the dielectric layer 11) and non-light-emitting cells (i.e. the discharge cells C in which no wall charges are generated on the dielectric layer 11) in all the display lines L are distributed over the panel in accordance with the image to be displayed.

After the completion of the addressing discharge, discharge-sustaining pulses are applied, simultaneously in all the display lines L, alternately to the row electrodes X and Y of the row electrode pair (X, Y) to cause discharge (sustaining discharge) in each light-emitting cell every application of the discharge-sustaining pulse.

By means of the sustaining discharge in each light-emitting cell, ultraviolet light is generated from xenon included in the discharge gas, and then excites the red, green or blue phosphor layer 16 provided in the light-emitting cell. As a result, the excited phosphor layers 16 emit colored light to form the image displayed.

In the PDP, a resistance value of each of the projecting electrodes Xb and Yb of the row electrodes X and Y is set in the following manner.

Specifically, the resistance of each of the projecting electrodes Xb and Yb of the row electrodes X and Y is set in such a manner as to fall within a range between 0.05 to 1.0 times the inductance (resistance) of the discharge space S during discharge peak current occurring in the discharge cell C when sustaining discharge is produced between the projecting electrodes Xb and Yb by the application of sustain pulses to the row electrodes X and Y.

For example, the discharge peak current flowing inside the discharge cell C when the discharge sustain pulse of 200V is applied to the row electrodes X and Y shows a value ranging from about 100 μA to about 200 μA, and at this point an inductance of the discharge space S ranges from 1 MΩ to 2 MΩ. Hence, a resistance of each of the projecting electrodes Xb and Yb is set at 10 KΩ/□ to 5 MΩ/□, preferably, at 500 KΩ/□.

If the resistance of the projecting electrode Xb, Yb is extremely high, the sustaining discharge is not easily produced. Therefore, a maximum resistance of the projecting electrode is limited to any value according to the inductance of the discharge space S during the discharge peak current.

Methods of increasing the resistance of the projecting electrode Xb, Yb to a greater resistance include: (1) a decrease in the thickness of the transparent conductive film forming each of the projecting electrodes Xb, Yb; (2) an increase in the amount of oxygen in the transparent conductive materials when the projecting electrodes Xb, Yb are formed; (3) the use of a high-resistance transparent electrode paste as materials for forming the projecting electrodes Xb, Yb; and the like.

In this manner, in the PDP according to the present invention, the projecting electrodes Xb, Yb of the row electrodes X, Y used for producing the sustaining discharge are designed to have high resistance. Thus, the discharge peak current when the sustaining discharge is produced is reduced.

The reduction in the discharge peak current leads to inhibition of occurrence of current waveform distortion, a reduction in luminous efficiency, and the like, resulting in an improvement of the display characteristics of the PDP.

With the foregoing PDP, because only the projecting electrodes Xb, Yb have high resistance, a reduction in the discharge peak current is achieved in each discharge cell C. This makes it possible to prevent the problem of “streaking” and the like that are caused by a voltage drop occurring when the row electrode itself has high resistance.

Further, in the PDP, a reduction in the discharge peak current makes it possible to reduce the heat generation (proportion to the square of the electric current) from the panel, and reduce the burden on the circuit for resisting heat.

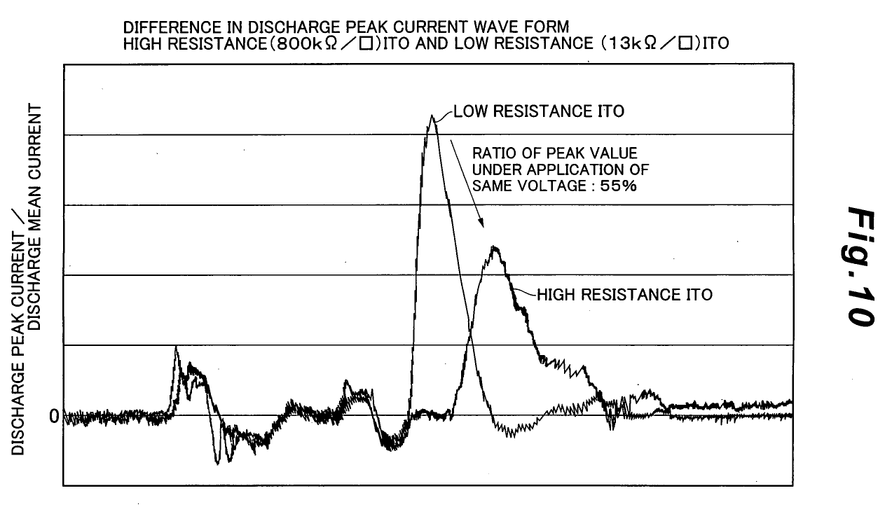

FIG. 10 is a graph showing a comparison between the discharge peak current generated by the projecting electrodes Xb, Yb having high resistance (800 KΩ/□) and the discharge peak current generated by conventional projecting electrodes having low resistance (13 Ω/□).

From FIG. 10, it is understood that the discharge peak current generated by the high resistance projecting electrodes Xb, Yb is reduced by 55 percent of the discharge peak current generated by the conventional low resistance projecting electrodes.

Next, a second embodiment according to the present invention is described. In the PDP having the same structure as that described in the first embodiment, each of the black-colored conductive layers Xa1, Ya1 respectively forming part of the bus electrodes Xa, Ya of the row electrodes X, Y is designed to have high resistance. The resistance of the black-colored conductive layer is set in such a manner as to fall within a range between 0.05 to 1.0 times the inductance (resistance) of the discharge space S during discharge peak current flowing in the discharge cell C when the sustaining discharge is produced.

For example, the discharge peak current flowing inside the discharge cell C when the discharge sustain pulse of 200V is applied to the row electrodes X and Y shows a value ranging from about 100 μA to about 200 μA, and at this point an inductance of the discharge space S ranges from 1 MΩ to 2 MΩ. Hence, a resistance of each of the black-colored conductive layers Xa1, Ya1 is set at 10 KΩ/□ to 5 MΩ/□ for each discharge cell C, preferably, at 500 KΩ/□.

If the resistance of the black-colored conductive layers Xa1, Ya1 is extremely high, the sustaining discharge is not easily produced. Therefore, a maximum resistance of the black-colored conductive layer is limited to any value according to inductance of the discharge space S during the discharge peak current.

Methods for increasing the resistance of the black-colored conductive layers Xa1, Ya1 to a greater resistance include: (1) a decrease in content of conductive materials (e.g. silver) in the black-colored conductive layers Xa1, Ya1; and (2) an increase in the film thickness of the black-colored conductive layers Xa1, Ya1; and the like.

In this manner, in the PDP according to the present invention, the black-colored conductive layers Xa1, Ya1 of the bus electrodes Xa, Ya of the row electrodes X, Y between which the sustaining discharge is caused are designed to have high resistance. Thus, the discharge peak current when the sustaining discharge is produced is reduced.

The reduction in the discharge peak current leads to inhibition of occurrence of current waveform distortion, a reduction in luminous efficiency, and the like, resulting in an improvement of the display characteristics of the PDP.

Further, in the PDP, a reduction in the discharge peak current makes it possible to reduce the heat generation (proportion to the square of the electric current) from the panel, and reduce the burden on the circuit for resisting heat.

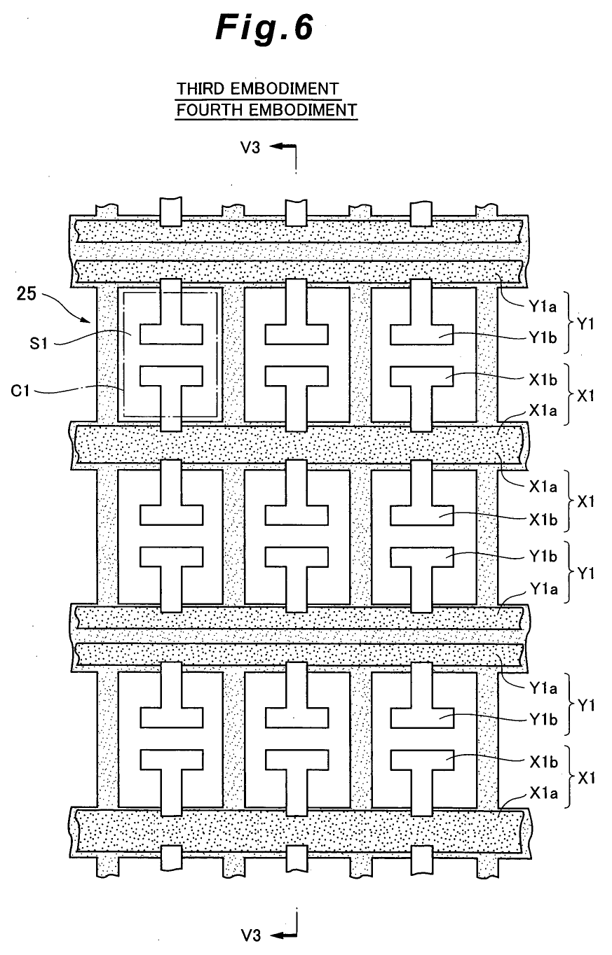

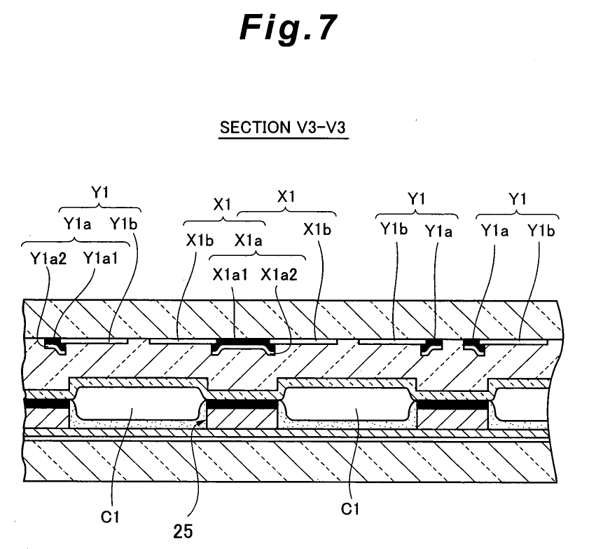

Next, FIGS. 6 and 7 illustrate a third embodiment according to the present invention. FIG. 6 is a schematic front view of the cell structure of a surface-discharge-type AC PDP in the third embodiment, and FIG. 7 is a sectional view taken along the V3-V3 line in FIG. 6.

The first embodiment has described the PDP of the structure in which the row electrodes X and Y of the row electrode pairs (X, Y) of the PDP are arranged in alternate positions in the column direction. In contrast, in the PDP of the third embodiment, a row electrode X1 in a row electrode pair (X1, Y1) shares a single bus electrode X1a with another row electrode X1 in a row electrode pair (X1, Y1) adjacent to the former row electrode pair (X1, Y1) Further, two bus electrodes Y1a of row electrodes Y1 in the adjacent row electrode pairs (X1, Y1) are located back to back with each other.

Projecting electrodes X1b of the adjacent row electrode pairs (X1, Y1) are connected to both edges of the single bus electrode X1a shared between these row electrode pairs (X1, Y1), and extend from the edges of the bus electrode X1a toward the other row electrodes Y1 in these row electrode pairs (X1, Y1) in the column direction (i.e. in the up and down directions in FIG. 6). Then the projecting electrodes X1b face the individually paired projecting electrodes Y1b.

The bus electrodes X1a and Y1a are formed in a double layer structure consisting of black-colored conductive layers X1a1, Y1a1 placed close to the display surface and main conductive layers X1a2, Y1a2 respectively placed behind the conductive layers X1a1, Y1a1.

In the PDP, a resistance value of each of the projecting electrodes X1b and Y1b of the row electrodes X1 and Y1 is set in the following manner.

Specifically, sustain pulses are applied to the row electrodes X1 and Y1 and thereby sustaining discharge is produced between the projecting electrodes X1b and Y1b. At this time, discharge peak current flows inside each of the discharge cells C1 into which a substantially grid-shaped partition wall member 25 partition a discharge space S1. The resistance of each of the projecting electrodes X1b and Y1b of the row electrodes X1 and Y1 is set in such a manner as to fall within a range between 0.05 to 1.0 times the inductance (resistance) of the discharge space S1 during the discharge peak current flowing in each discharge cell C1.

For example, the discharge peak current flowing inside the discharge cell C1 when the discharge sustain pulse of 200V is applied to the row electrodes X1 and Y1 shows a value ranging from about 100 μA to about 200 μA, and at this point an inductance of the discharge space S1 ranges from 1 MΩ to 2 MΩ. Hence, a resistance of each of the projecting electrodes X1b and Y1b is set at 10 KΩ/□ to 5 MΩ/□, preferably, at 500 KΩ/□.

If the resistance of the projecting electrode X1b, Y1b is extremely high, the sustaining discharge is not easily produced. Therefore, a maximum resistance of the projecting electrode is limited to any value according to inductance of the discharge space S1 during the discharge peak current.

Methods of increasing the resistance of the projecting electrode X1b, Y1b to a greater resistance include: (1) a decrease in the film thickness of the transparent conductive film forming each of the projecting electrodes X1b, Y1b; (2) an increase in the amount of oxygen in the transparent conductive materials when the projecting electrodes X1b, Y1b are formed; (3) the use of a high-resistance transparent electrode paste as materials for forming the projecting electrodes X1b, Y1b; and the like.

In this manner, in the PDP according to the present invention, the projecting electrodes X1b, Y1b of the row electrodes X1, Y1 between which the sustaining discharge is caused are designed to have high resistance. Thus, the discharge peak current when the sustaining discharge is produced is reduced.

The reduction in the discharge peak current leads to inhibition of occurrence of current waveform distortion, a reduction in luminous efficiency, and the like, resulting in an improvement of the display characteristics of the PDP.

With the foregoing PDP, because the projecting electrodes X1b, Y1b have high resistance, a reduction in the discharge peak current is achieved in each discharge cell C1. This makes it possible to prevent the problem of “streaking” and the like that are caused by a voltage drop occurring when the row electrode itself has high resistance.

Further, in the PDP, a reduction in the discharge peak current makes it possible to reduce the heat generation (proportion to the square of the electric current) from the panel, and reduce the burden on the circuit for resisting heat.

Next, a fourth embodiment according to the present invention is described. In the PDP having the same structure as that described in FIGS. 6 and 7, each of the black-colored conductive layers X1a1, Y1a1 respectively forming part of the bus electrodes X1a, Y1a of the row electrodes X1, Y1 is designed to have high resistance. The resistance of the black-colored conductive layer is set in such a manner as to fall within a range between 0.05 to 1.0 times an inductance (resistance) of the discharge space S1 during discharge peak current flowing in the discharge cell C1 when the sustaining discharge is produced.

For example, the discharge peak current flowing inside the discharge cell C1 when the discharge sustain pulse of 200V is applied to the row electrodes X1 and Y1 shows a value ranging from about 100 μA to about 200 μA, and at this point an inductance of the discharge space S1 ranges from 1 MΩ to 2 MΩ. Hence, a resistance of each of the black-colored conductive layers X1a1, Y1a1 is set at 10 KΩ/□ to 5 MΩ/□ for each discharge cell C1, preferably, at 500 KΩ/□.

If the resistance of the black-colored conductive layers X1a1, Y1a1 is extremely high, the sustaining discharge is not easily produced. Therefore, a maximum resistance of the black-colored conductive layer is limited to a value according to inductance of the discharge space S1 during the discharge peak current.

Methods for increasing the resistance of the black-colored conductive layers X1a1, Y1a1 to a greater resistance include: (1) a decrease in content of conductive materials (e.g. silver) in the black-colored conductive layers X1a1, Y1a1; (2) an increase in the film thickness of the black-colored conductive layers X1a1, Y1a1; and the like.

In this manner, in the PDP according to the present invention, by means of the setting of the resistance of each of the black-colored conductive layers X1a1, Y1a1 of the bus electrodes X1a, Y1a of the row electrodes X1, Y1 between which the sustaining discharge is caused, a reduction in the discharge peak current generated when the sustaining discharge is produced is achieved.

The reduction in the discharge peak current leads to inhibition of occurrence of current waveform distortion, a reduction in luminous efficiency, and the like, resulting in an improvement of the display characteristics of the PDP.

Further, in the PDP, a reduction in the discharge peak current makes it possible to reduce the heat generation (proportion to the square of the electric current) from the panel, and reduce the burden on the circuit for resisting heat.

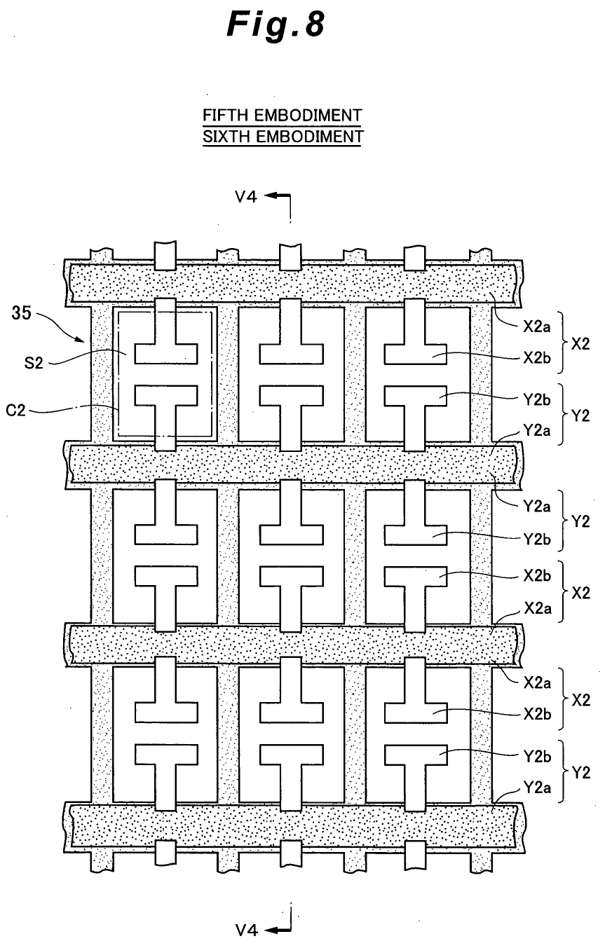

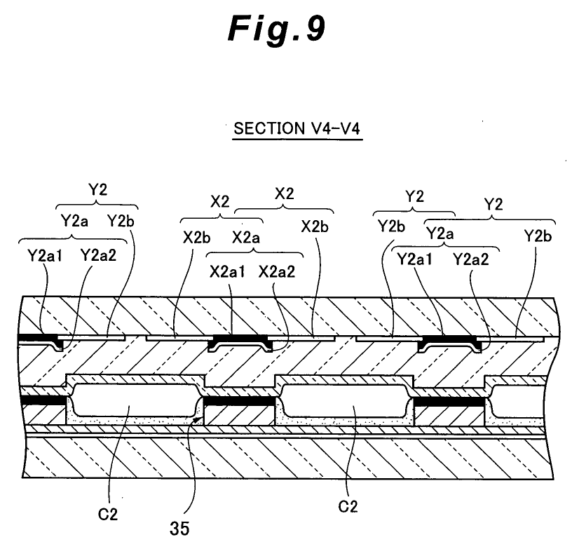

Next, FIGS. 8 and 9 illustrate a fifth embodiment according to the present invention. FIG. 8 is a schematic front view of the cell structure of a surface-discharge-type AC PDP in the fifth embodiment, and FIG. 9 is a sectional view taken along the V4-V4 line in FIG. 8.

The third embodiment has described the PDP of the structure in which only the row electrode X1 in each row electrode pair (X1, Y1), excluding the row electrode Y1, shares the single bus electrode X1a with another row electrode X1 in the adjacent row electrode pair (X1, Y1). In contrast, in the PDP of the fifth embodiment, both row electrodes X2, Y2 of each row electrode pair (X2, Y2) share individual single bus electrodes X2a, Y2a with row electrodes X2, Y2 of another row electrode pair (X2, Y2) adjacent to the former row electrode pair (X2, Y2).

Projecting electrodes X2b, Y2b are connected to both edges of the single bus electrodes X2a, Y2a shared between adjacent row electrode pairs (X2, Y2). The projecting electrodes X2b extend from both edges of the associated bus electrode X2a toward the row electrodes Y2 respectively paired with the associated row electrodes X2 in the column direction (i.e. the up and down directions in FIG. 8). Then, the projecting electrodes X2b face the individually paired projecting electrodes Y2b. Likewise the projecting electrodes Y2b extend from both edges of the bus electrode Y2a in the column direction so as to face the individually paired projecting electrodes X2b.

The bus electrodes X2a and Y2a are formed in a double layer structure consisting of black-colored conductive layers X2a1, Y2a1 placed close to the display surface and main conductive layers X2a2, Y2a2 respectively placed behind the conductive layers X2a1, Y2a1.

In the PDP, resistance of each of the projecting electrodes X2b and Y2b of the row electrodes X2 and Y2 is set in the following manner.

Specifically, sustain pulses are applied to the row electrodes X2 and Y2 and thereby sustaining discharge is produced between the projecting electrodes X2b and Y2b. At this time, discharge peak current flows inside each of the discharge cells C2 into which a substantially grid-shaped partition wall member 35 partition a discharge space S2. The resistance of each of the projecting electrodes X2b and Y2b of the row electrodes X2 and Y2 is set in such a manner as to fall within a range between 0.05 to 1.0 times the inductance (resistance) of the discharge space S2 during discharge peak current flowing in each discharge cell C2.

For example, the discharge peak current flowing inside the discharge cell C2 when the discharge sustain pulse of 200V is applied to the row electrodes X2 and Y2 shows a value ranging from about 100 μA to about 200 μA, and at this point an inductance of the discharge space S2 ranges from 1 MΩ to 2 MΩ. Hence, a resistance of each of the projecting electrodes X2b and Y2b is set at 10 KΩ/□ to 5 MΩ/□, preferably, at 500 KΩ/□.

If the resistance of the projecting electrode X2b, Y2b is extremely high, the sustaining discharge is not easily produced. Therefore, a maximum resistance of the projecting electrode is limited to any value according to inductance of the discharge space S2 during discharge peak current.

Methods of increasing the resistance of the projecting electrode X2b, Y2b to a greater resistance include: (1) a decrease in the film thickness of the transparent conductive film forming each of the projecting electrodes X2b, Y2b; (2) an increase in the amount of oxygen in the transparent conductive materials when the projecting electrodes X2b, Y2b are formed; (3) the use of a high-resistance transparent electrode paste as materials for forming the projecting electrodes X2b, Y2b; and the like.

In this manner, in the PDP according to the present invention, each of the projecting electrodes X2b, Y2b of the row electrodes X2, Y2 between which the sustaining discharge is caused is designed to have high resistance. Thus, the discharge peak current when the sustaining discharge is produced is reduced.

The reduction in the discharge peak current leads to inhibition of occurrence of current waveform distortion, a reduction in luminous efficiency, and the like, resulting in an improvement of the display characteristics of the PDP.

With the foregoing PDP, further, because the projecting electrodes X2b, Y2b have high resistance, a reduction in the discharge peak current is achieved in each discharge cell C2. This makes it possible to prevent the problem of “streaking” and the like that are caused by a voltage drop occurring when the row electrode itself has high resistance.

Further, in the PDP, a reduction in the discharge peak current makes it possible to reduce the heat generation (proportion to the square of the electric current) from the panel, and reduce the burden on the circuit for resisting heat.

Then, a sixth embodiment according to the present invention is described. In the PDP having the same structure as that described in FIGS. 8 and 9, the resistance of each of the black-colored conductive layers X2a1, Y2a1 respectively forming part of the bus electrodes X2a, Y2a of the row electrodes X2, Y2 is set at a high value in such a manner as to fall within a range between 0.05 to 1.0 times the inductance (resistance) of the discharge space S2 during discharge peak current flowing in the discharge cell C2 when the sustaining discharge is produced.

For example, the discharge peak current flowing inside the discharge cell C2 when the discharge sustain pulse of 200V is applied to the row electrodes X2 and Y2 shows a value ranging from about 100 μA to about 200 μA, and at this point an inductance of the discharge space S2 ranges from 1 MΩ to 2 MΩ. Hence, a resistance of each of the black-colored conductive layers X2a1, Y2a1 is set at 10 KΩ/□ to 5 MΩ/□ for each discharge cell C2, preferably, at 500 KΩ/□.

If the resistance of the black-colored conductive layers X2a1, Y2a1 is extremely high, the sustaining discharge is not easily produced. Therefore, a maximum resistance of the black-colored conductive layer is limited to any value according to inductance of the discharge space S2 during the discharge peak current.

Methods for increasing the resistance of the black-colored conductive layers X2a1, Y2a1 to a greater resistance include: (1) a decrease in content of conductive materials (e.g. silver) in the black-colored conductive layers X2a1, Y2a1; (2) an increase in the film thickness of the black-colored conductive layers X2a1, Y2a1; and the like.

In this manner, in the PDP according to the present invention, electrode resistance is increased such that the black-colored conductive layers X2a1, Y2a1 of the bus electrodes X2a, Y2a of the row electrodes X2, Y2 between which the sustaining discharge is caused have high resistance. Thus, the discharge peak current when the sustaining discharge is produced is reduced.

The reduction in the discharge peak current leads to inhibition of occurrence of current waveform distortion, a reduction in luminous efficiency, and the like, resulting in an improvement of the display characteristics of the PDP.

Further, in the PDP, a reduction in the discharge peak current makes it possible to reduce the heat generation (proportion to the square of the electric current) from the panel, and reduce the burden on the circuit for resisting heat.

The terms and description used herein are set forth by way of illustration only and are not meant as limitations. Those skilled in the art will recognize that numerous variations are possible within the spirit and scope of the invention as defined in the following claims.

1. A plasma display panel, comprising:
a pair of substrates that are placed opposite each other with a discharge space in between;
a plurality of row electrode pairs that are provided between the substrates; and
a plurality of column electrodes that are provided between the substrates and each extends in a direction at right angles to the row electrode pair to form unit light emission areas at intersections with the row electrode pairs within the discharge space,
each of the row electrode pairs being constituted of row electrodes, and the row electrode including a portion that faces the unit light emission area and has a resistance value between 0.05 to 1.0 times inductance of the discharge space during discharge peak current occurring in the unit light emission area by discharge produced between the paired row electrodes of the row electrode pair.

2. A plasma display panel according to claim 1, wherein the portion of the row electrode facing the unit light emission area has a resistance value ranging from 1 kΩ/□ to 5 MΩ/□.

3. A plasma display panel according to claim 1, wherein the resistance value of the portion of the row electrode facing the unit light emission area is 500 kΩ/□.

4. A plasma display panel according to claim 1, wherein each of the row electrodes constituting the row electrode pair includes an electrode body that extends in a row direction, and projecting electrode portions that each project from the electrode body toward the other row electrode paired with the associated row electrode to face a projecting electrode portion of the other row electrode with a discharge gap in between, and that have a resistance value between 0.05 to 1.0 times inductance of the discharge space during discharge peak current occurring in the unit light emission area.

5. A plasma display panel according to claim 4, wherein the projecting electrode portion of the row electrode has a resistance value ranging from 1 kΩ/□ to 5 MΩ/□.

6. A plasma display panel according to claim 4, wherein the resistance value of the projecting electrode portion of the row electrode is 500 kΩ/□.

7. A plasma display panel according to claim 4, wherein the resistance value is determined by its dependence on a thickness of the projecting electrode portion.

8. A plasma display panel according to claim 4, wherein the resistance value is determined by its dependence on an amount of oxygen when the projecting electrode portion is formed.

9. A plasma display panel according to claim 4, wherein the resistance value is determined by its dependence on use of a high-resistance conductive material for forming the projecting electrode portion.

10. A plasma display panel according to claim 4, wherein each of the projecting electrode portions projects from the associated electrode body toward the other row electrode paired with the associated row electrode in each unit light emission area.

11. A plasma display panel according to claim 1, wherein
each of the row electrodes constituting the row electrode pair includes an electrode body that extends in a row direction, and projecting electrode portions that each projects from the electrode body toward the other row electrode paired with the row electrode to face a projecting electrode portion of the paired row electrode with a discharge gap in between, and
the row electrode body is formed in a multilayer manner and a layer forming part of the electrode body has a resistance value between 0.05 to 1.0 times inductance of the discharge space during discharge peak current flowing in the unit light emission area.

12. A plasma display panel according to claim 11, wherein the layer forming the part of the electrode body has a resistance value ranging from 1 kΩ/□ to 5 MΩ/□.

13. A plasma display panel according to claim 4, wherein the resistance value of the layer forming the part of the electrode body is 500 kΩ/□.

14. A plasma display panel according to claim 4, wherein the resistance value is determined by decreasing content of a conductive material in the layer forming the part of the electrode body.

15. A plasma display panel according to claim 14, wherein the conductive material, of which the content is decreased, is silver.

16. A plasma display panel according to claim 11, wherein the resistance value is determined by its dependence on a thickness of the layer forming the part of the electrode body.

17. A plasma display panel according to claim 11, wherein the layer forming the part of the electrode body is a black-colored conductive layer.

18. A plasma display panel according to claim 11, wherein the electrode body of at least one row electrode in the row electrode pair is shared with one row electrode in another row electrode pair adjacent to the row electrode pair.

19. A plasma display panel according to claim 11, wherein each of the electrode bodies of the respective row electrodes constituting the row electrode pair is shared with one row electrode in the row electrode pair adjoining to the row electrode pair.
